(19) United States
(12) Patent Application Publication
(10) Pub. No.: US 2008/0282534 A1
(43) Pub. Date: Nov. 20, 2008

(54) Apparatus for attachment of hydraulic values for controlling working devices of heavy equipment

(75) Inventors: Young Jin Son, Changwon-si (KR); Joon Seog Go, Changwon-si (KR)

Correspondence Address: LADAS & PARRY LLP, 26 WEST 61ST STREET, NEW YORK, NY, 10023, US

(73) Assignee: VOLVO CONSTRUCTION EQUIPMENT HOLDING SWEDEN AB.

(21) Appl. No.: 12/151,297

(22) Filed: May 6, 2008

(30) Foreign Application Priority Data
May 17, 2007 (KR) 10-2007-0048176

(51) Int. Cl. B23P 19/00

(52) U.S. Cl. 29/795

(57) ABSTRACT

An apparatus for attachment of hydraulic valves for controlling working devices of heavy equipment is provided, which can reduce a lead time for attaching and assembling a main control valve, an accessory valve, and valve blocks for jointly connecting the respective valves with hydraulic piping, to an upper swing structure. The apparatus includes a lower driving structure and an upper swing structure, a cabin and an engine room, working devices fixed to the upper swing structure, a main control valve shifted in accordance with an operation signal from an operation lever and including spools for controlling a supply amount and a flow direction of hydraulic fluid fed to the corresponding working devices, a sub-plate attached to a specified position of the upper swing structure, an accessory valve installed on the sub-plate and controlling hydraulic fluid fed to the main control valve, and valve blocks installed on the sub-plate and jointly connecting the main control valve and the accessory valve with hydraulic pipes. The sub-plate is attached to the upper swing structure after the main control valve, the accessory valve, and the valve blocks are installed on the sub-plate, and the respective valves are connected with the hydraulic piping.

### CROSS-REFERENCE TO RELATED APPLICATION

This application is based on and claims priority from Korean Patent Application No. 10-2007-0048176, filed on May 17, 2007 in the Korean Intellectual Property Office, the disclosure of which is incorporated herein in its entirety by reference.

### BACKGROUND OF THE INVENTION

1. Field of the invention

The present invention relates to an apparatus for attachment of hydraulic valves for controlling working devices of heavy equipment, which can reduce a lead time for attaching and assembling a main control valve for controlling hydraulic fluid being fed from a hydraulic pump to drive the working devices such as a boom and so on, an accessory valve, and various kinds of valve blocks (hereinafter referred to as “hydraulic valves”) for jointly connecting the respective valves with hydraulic piping (hydraulic hoses or hydraulic pipes), to an upper swing structure.

More particularly, the present invention relates to an apparatus for attachment of hydraulic valves for controlling working devices of heavy equipment, which can reduce a lead time for assembly by improving assemblage and workability of the hydraulic valves through attachment of a sub-plate to an upper swing structure after the hydraulic valves are attached and assembled to the sub-plate.

2. Description of the Prior Art

As illustrated in FIG. 1, a general excavator includes a lower driving structure 1; an upper swing structure 2 mounted on the lower driving structure 1 and being swiveled in left and right directions; a cabin 3 and an engine room 4 mounted in front and in the rear of the upper swing structure 2; working devices 11 fixed to the upper swing structure 2, and including a boom 6 driven by a boom cylinder 5, an arm 8 driven by an arm cylinder 7, and a bucket 10 driven by a bucket cylinder 9; a main control valve 12 shifted in accordance with a user operation signal from an operation lever RCV, and including spools for controlling a supply amount and a flow direction of hydraulic fluid fed to the corresponding working devices 11 during the shifting of the main control valve; and a counterweight 13 attached to the rear of the upper swing structure 2 to valance the equipment.

As illustrated in FIG. 2, according to a conventional apparatus for attachment of hydraulic valves for controlling working devices of heavy equipment, the main control valve 12 including spools for controlling hydraulic fluid being supplied to the working devices is installed in the center of the rear side of the upper swing structure 2, and an accessory valve including solenoid valves and so on are installed in a space adjacent to the main control valve 12. The main control valve 12 and the accessory valve 15 are jointly connected with each other through hydraulic hoses s or hydraulic pipes.

In this case, the option valves 15 include a selector valve, a solenoid valve, a shuttle valve, valve blocks 16 (e.g. a confluence block, a drain block, and the like), an electric proportional control valve, and the like.

The main control valve 12 and the accessory valve 15 are mounted in specified positions of the upper swing structure 2 that is put on an assembly line of the equipment, and then the valves are jointly connected with each other through the hydraulic hoses s.

That is, a work process of installing the hydraulic valves in the upper swing structure 2 and a work process of jointly connecting the hydraulic valves with hydraulic hoses are separately performed, and this causes the assembling time and the manufacturing cost to be increased.

Also, in order for an operator to connect the hydraulic hoses, he must get on the upper swing structure 2 having a small work space and conduct the corresponding work in the small work space, so that the working efficiency is lowered.

On the other hand, in the case of zero tail type equipment (e.g., rear zero tail type equipment), although not illustrated in the drawing, the length of the upper swing structure 2 is set to be shorter than that in general equipment in order to reduce the radius of swing.

Accordingly, due to insufficient space for attachment of the main control valve 12 to the upper swing structure 2, the main control valve 12 may be installed on the right side of a boom, and the accessory valve 15 may be installed in the neighborhood of the main control valve 12. Alternatively, the accessory valve 15 may be installed in the upper swing structure 2, and the valves are jointly connected with hydraulic hoses and so on.

As described above, since the attachment and assembly of various kinds of hydraulic valves in a narrow space provided in the upper swing structure are laborious, the workability and assimilability are lowered, and the lead time for assembling the equipment and the whole manufacturing cost are increased.

### SUMMARY OF THE INVENTION

Accordingly, the present invention has been made to solve the above-mentioned problems occurring in the prior art, and an object of the present invention is to provide an apparatus for attachment of hydraulic valves for controlling working devices of heavy equipment, which can reduce a manufacturing cost of the equipment by shortening a lead time for attaching and assembling the hydraulic valves to an upper swing structure through attachment of a sub-plate to the upper swing structure after the hydraulic valves are attached and assembled to the sub-plate, and improve the assemblage and workability of the hydraulic valves by facilitating the attachment and assembly work.

In order to accomplish these objects, there is provided an apparatus for attachment of hydraulic valves for controlling working devices of heavy equipment, according to the present invention, which includes a lower driving structure and an upper swing structure mounted on the lower driving structure and being swiveled in left and right directions; a cabin and an engine room mounted on the upper swing structure; working devices fixed to the upper swing structure, and including a boom, an arm, and a bucket driven by hydraulic cylinders; a main control valve shifted in accordance with an operation signal from an operation lever, and including spools for controlling a supply amount and a flow direction of hydraulic fluid fed to the corresponding working devices during the shifting of the main control valve; a sub-plate attached to a specified position of the upper swing structure; an accessory valve installed on the sub-plate and controlling hydraulic fluid fed to the main control valve; and valve blocks installed on the sub-plate and jointly connecting the main control valve and the accessory valve with hydraulic pipes; wherein the main control valve, the accessory valve, and the valve blocks are installed on the sub-plate, the respective valves are connected with the hydraulic piping, and then the sub-plate is attached to the upper swing structure.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view of a general excavator;

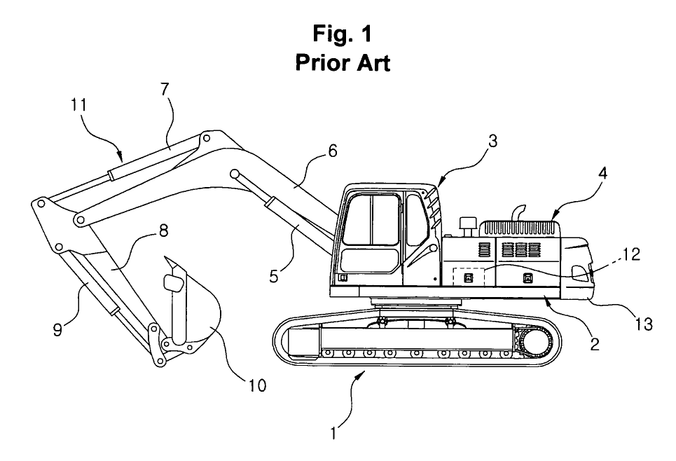

FIG. 2 is a schematic view of a conventional apparatus for attachment of hydraulic valves for controlling working devices of heavy equipment;

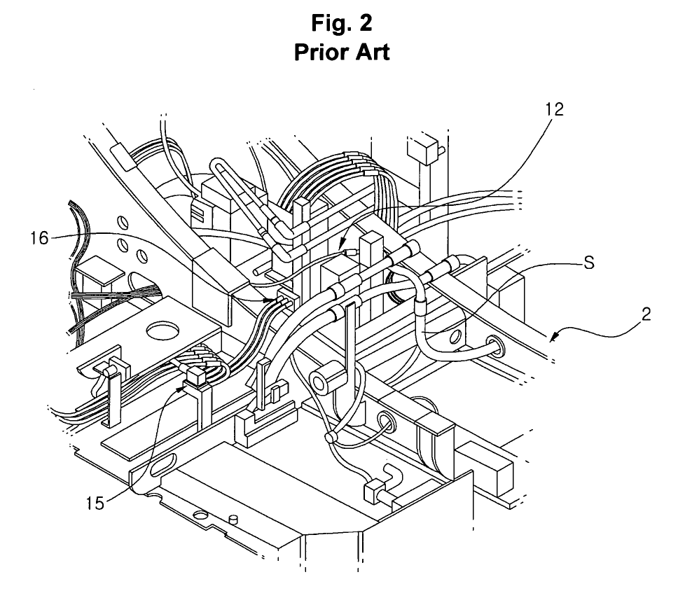

FIG. 3 is a schematic view of a sub-plate on which hydraulic valves are mounted in an apparatus for attachment of hydraulic valves for controlling working devices of heavy equipment according to an embodiment of the present invention; and

FIG. 4 is a schematic view of an apparatus for attachment of hydraulic valves for controlling working devices of heavy equipment in a used state according to an embodiment of the present invention.

### DETAILED DESCRIPTION OF THE PREFERRED EMBODIMENTS

Hereinafter, preferred embodiments of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto.

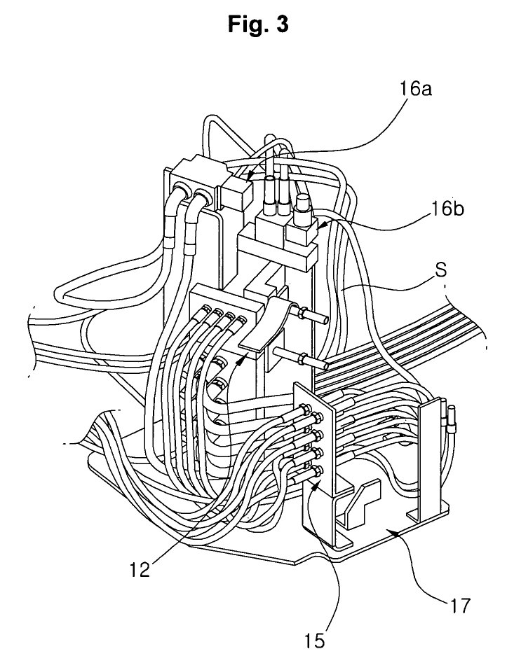

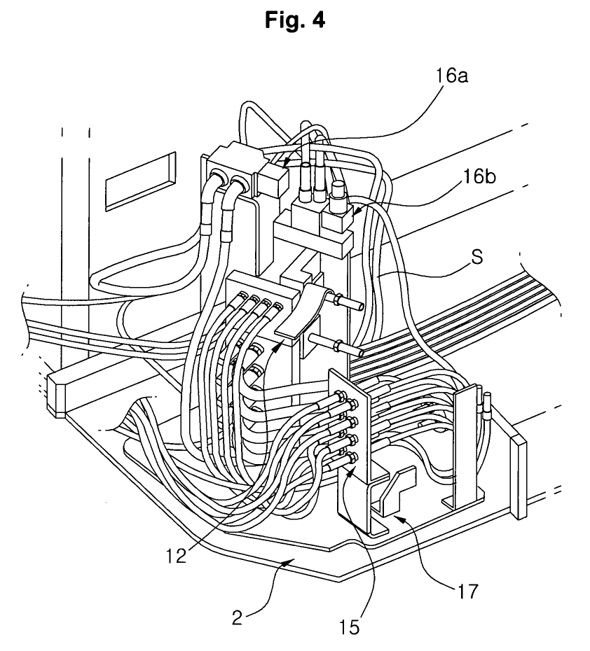

As shown in FIGS. 3 and 4, an apparatus for attachment of hydraulic valves for controlling working devices of heavy equipment according to the present invention includes a lower driving structure 1, an upper swing structure 2 mounted on the lower driving structure 1 and being swiveled in left and right directions; a cabin 3 and an engine room 4 mounted on the upper swing structure 2; working devices 11 fixed to the upper swing structure 2, and including a boom 6, an arm 8, and a bucket 10 driven by hydraulic cylinders 5, 7, and 9; a main control valve (MCV) 12 shifted in accordance with an operation signal from an operation lever (RCV), and including spools for controlling a supply amount and a flow direction of hydraulic fluid fed to the corresponding working devices during the shifting of the main control valve; a sub-plate 17 attached to a specified position of the upper swing structure 2; an accessory valve 15 installed on the sub-plate 17 and controlling hydraulic fluid fed from a hydraulic pump (not illustrated) to the main control valve 12; and valve blocks 16a and 16b installed on the sub-plate 17 and jointly connecting the main control valve 12 and the accessory valve 15 with hydraulic pipes (or hydraulic hoses s). The main control valve 12, the accessory valve 15, and the valve blocks 16a and 16b are installed on the sub-plate 17, the respective valves 12, 15, 16a, and 16b are connected with the hydraulic piping, and then the sub-plate 17 is attached to the upper swing structure 2.

The operation of the apparatus for attachment of hydraulic valves for controlling working devices of heavy equipment according to an embodiment of the present invention will be described with reference to accompanying drawings.

As illustrated in FIGS. 3 and 4, after the hydraulic valves (e.g. the main control valve 12, the accessory valve 15, and the valve blocks 16a and 16b) for supplying the hydraulic fluid from the hydraulic pump to the working devices 11 or returning the hydraulic fluid to the hydraulic pump are installed on the sub-plate 17, the main control valve 12, the accessory valve 15, and the valve blocks 16a and 16b are jointly connected with the hydraulic hoses s. That is, a work process of installing the hydraulic valves 12, 15, 16a, and 16b on the sub-plate 17 and a work process of jointly connecting the hydraulic valves with the hydraulic hoses s are simultaneously performed as a single work process.

As described above, after the attachment of the hydraulic valves to a specified position of the sub-plate 17 and the connection of the hydraulic valves with the hydraulic hoses s are performed, the sub-plate, to which the hydraulic valves are attached, is attached to a specified position of the upper swing structure 2 to complete the attachment and the assembly of the hydraulic valves to the upper swing structure 2.

That is, the work process of installing the main control valve 12, the accessory valve 15, and the valve blocks 16a and 16b on the sub-plate and the work process of jointly connecting the respective valves with the hydraulic hoses s are simultaneously performed.

Accordingly, the corresponding work can be easily performed without being restricted in space, and thus the working efficiency can be improved. By contrast, according to the conventional apparatus for attachment of hydraulic valves for controlling working devices of heavy equipment, an operator gets on the upper swing structure 2, installs the valves 12 and 15 in a specified position of the upper swing structure 2, and jointly connects the valves with the hydraulic to cause the workability to be lowered.

In addition, the work process of installing various kinds of valves 12, 15, 16a, and 16b on the sub-plate 17 and the work process of jointly connecting the valves 12, 15, 16a, and 16b with the hydraulic hoses s can be performed as a single work process.

Accordingly, a lead time required for the work process of installing the valves 12, 15, 16a, and 16b on the sub-plate 17 and the work process of connecting the valves with the hydraulic hoses s is shortened, and thus the manufacturing cost of the equipment can be reduced. By contrast, according to the conventional apparatus, various kinds of valves 12 and 15 are installed in the upper swing structure 2, and then the valves 12 and 15 are jointly connected with the hydraulic hoses s, as separate first and last work processes.

As described above, the apparatus for attachment of hydraulic valves for controlling working devices of heavy equipment according to an embodiment of the present invention has the following advantages.

A sub-plate is attached to an upper swing structure after hydraulic valves are attached and assembled to the sub-plate, and thus a lead time for attaching and assembling the hydraulic valves to the upper swing structure is shortened to reduce a manufacturing cost of the equipment. Also, the sub-plate can be easily attached to the upper swing structure in a narrow space, and thus the assemblage and workability of the hydraulic valves can be improved.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An apparatus for attachment of hydraulic valves for controlling working devices of heavy equipment, comprising:
a lower driving structure and an upper swing structure mounted on the lower driving structure and being swiveled in left and right directions;
a cabin and an engine room mounted on the upper swing structure;
working devices fixed to the upper swing structure, and including a boom, an arm, and a bucket driven by hydraulic cylinders;
a main control valve shifted in accordance with an operation signal from an operation lever, and including spools for controlling a supply amount and a flow direction of hydraulic fluid fed to the corresponding working devices during the shifting of the main control valve;
a sub-plate attached to a specified position of the upper swing structure;
an accessory valve installed on the sub-plate and controlling hydraulic fluid fed to the main control valve; and
valve blocks installed on the sub-plate and jointly connecting the main control valve and the accessory valve with hydraulic piping;
wherein the main control valve, the accessory valve, and the valve blocks are installed on the sub-plate, the respective valves are connected with the hydraulic pipes, and then the sub-plate is attached to the upper swing structure.
